(19) United States
(12) Patent Application Publication
(10) Pub. No.: US 2015/0262504 A1
(43) Pub. Date: Sep. 17, 2015

(54) TOOTHBRUSH-DEMONSTRATION DEVICE AND SYSTEM

(71) Applicant: The Procter & Gamble Company, Cincinnati, OH (US)

(72) Inventors: Nicole Moulinier, Caracas (VE); Erika Sánchez, Caracas (VE); Roger Zambrano, Caracas (VE); Matthew Lloyd NEWMAN, Cincinnati, OH (US)

(73) Assignee: The Procter & Gamble Company, Cincinnati, OH (US)

(21) Appl. No.: 14/206,249

(22) Filed: Mar. 12, 2014

(51) Int. Cl. G09B 19/00

(52) U.S. Cl. CPC G09B 19/0084

(57) ABSTRACT

A toothbrush-demonstration device and system. The device has a main body and comprising a plurality of toothbrush holders, each of the toothbrush holders being structured and configured to accept and removably secure therein a single toothbrush in a fixed position, the toothbrush comprising a handle and a head including a plurality of cleaning elements, wherein a plurality of toothbrushes can be securely mounted substantially parallel to one another in the plurality of toothbrush holders for a simultaneous movement with the device relative to a test surface. The system includes the device, two toothbrushes being compared, and a test surface.

### FIELD OF THE INVENTION

The present invention is directed to a toothbrush-demonstration device for comparing and demonstrating efficacies of two or several toothbrushes.

### BACKGROUND

It is well known that accumulation of dental plaque is a major cause of many dental problems, such as, e.g., the formation and progress of dental caries, as well as inflammatory gingival and periodontal diseases. Therefore, efficient plaque removal plays a significant role in improving and maintaining dental health. Daily use of a toothbrush is one of the most dependable ways to achieve oral-health benefits. The current oral-care market's demands encourage manufacturers of oral-care goods to create new oral-care implements, such as toothbrushes, that would appeal to consumers because of their plague-removal efficacy.

There are known ways, including scientific studies, of establishing and demonstrating the plague-removal efficacy of one toothbrush compared to others, such as, e.g., clinical trials, laboratory tests, and consumer-based trials. These methods usually require lengthy and time-consuming procedures, and their results typically involve interpretation not readily available to consumers. There is a need, therefore, for a relatively simple and inexpensive way of comparing one or several toothbrushes with respect to their plague-removal efficacy. To address this need, the present invention is directed to a toothbrush-demonstration device and a toothbrush-demonstration system. While the device and system of the invention are not intended to replace clinical studies and other types of scientific methods of evaluating efficacy of toothbrushes, they offers a readily accessible visual comparison of plague-removal efficacy of two or several toothbrushes, including manual toothbrushes and electrical toothbrushes.

### SUMMARY OF THE INVENTION

In one aspect, the invention is directed to a toothbrush-demonstration device having a main body and comprising a plurality of toothbrush holders, each designed to accept and secure a single toothbrush in a fixed position. This device can be used with virtually any toothbrush comprising a handle and a head having a support element and a plurality of cleaning elements outwardly extending from the support element. The device is designed to accept and securely mount simultaneously two or more toothbrushes, either manual or electrical. The toothbrushes can be securely mounted in the toothbrush holders to be substantially parallel to one another.

The toothbrushes can be secured in the toothbrush holders by using a mechanical clamping mechanism. In one embodiment, the clamping mechanism comprises two mutually opposite clamping surfaces that are configured to apply a clamping force to a portion of a body of the toothbrush, e.g., the toothbrush handle, thereby securing the toothbrush in the holder. In one particular embodiment, the clamping mechanism includes two substantially parallel and mutually opposite plates, an upper plate and a lower plate. The plates can be movingly coupled to one another with one or several screws such that a distance between the first inner surface and the second inner surface can be varied. In one particular embodiment, the plates are coupled by a pair of screws disposed at opposite sides of the device.

The upper plate has a first inner surface, and the lower plate has a second inner surface facing and spaced from the first inner surface. The first inner surface may include a plurality of first clamping surfaces, and the second inner surface may include a plurality of second clamping surfaces. These opposing clamping surfaces can be structured to form a plurality of clamping couples for accepting and securing the plurality of toothbrushes therein. The plurality of toothbrushes may include manual toothbrushes or electrical toothbrushes—and may be configured to accept and secure therein toothbrushes having differential shapes.

In one embodiment, the device comprises weight-adjusting means for adjusting an overall weight of the device. Such weight-adjusting means may comprise a weight receptacle for receiving one or more additional-weight element, such as, e.g., metal weight tokens and the like. The weight receptacle can be conveniently located on the upper plate's top surface.

The device may conveniently include a handle for manual movement of the device relative to a test surface simulating a surface of a tooth having a plaque-imitating or stain-imitating substance thereon. Any suitable shape of the handle can be utilized. Alternatively or additionally, the device can have an electrical mechanism for reciprocally moving the device relative to the test surface. Such an electrical mechanism may comprise, e.g., a battery-powered slider-crank mechanism or the like.

In another aspect, the invention is directed to the toothbrush-demonstration device in combination with at least two different toothbrushes secured in the device for simultaneous movement relative to the test surface. Each of the toothbrushes is securely mounted in the toothbrush holder such that their cleaning elements extend in a direction away from the main body of the device, wherein the cleaning elements of the toothbrushes touch the test surface simultaneously and under approximately equal pressure against the test surface. If the device is used in combination with electrical toothbrushes, these electrical toothbrushes can be selected to differ from one another in shape and size of the handle; parameters of the cleaning elements, including material, size, shape, inclination angle, pattern of distribution of the cleaning elements, and the like; pattern of a mechanical movement of the cleaning elements; and frequency and amplitude of the mechanical movement of the cleaning elements. If the device is used in combination with manual toothbrushes, these manual toothbrushes can differ from one another with respect to shape and size of the handle, as well as material, size, shape, inclination angles, and pattern of the cleaning elements.

In one further aspect, the invention is directed to a toothbrush-demonstration system comprising at least a first toothbrush and a second toothbrush, the toothbrush-demonstration device as described herein; and a test surface comprising a tooth-surface-simulating substrate, which can be stained with a plaque-simulating substance. In the demonstration system, when the toothbrushes are secured in the toothbrush holders the cleaning elements of the first toothbrush and the cleaning elements of the second toothbrush extend in a direction substantially perpendicular to the test surface, and tips of the cleaning elements of the first toothbrush and tips of the cleaning elements of the second toothbrush are substantially aligned with respect to the test surface. Optionally, the system may include one or more dentifrice.

The invention is also directed to a process for demonstrating efficacy of one toothbrush relative to another. The process comprises fastening a first toothbrush and a second toothbrush to the toothbrush-demonstration device for simultaneous movement therewith relative to the test surface, wherein the toothbrushes are oriented I parallel to one another; moving the device with the first and second toothbrushes fastened thereto in a direction substantially parallel to the toothbrushes' mutually parallel orientation and relative to the test surface so that the cleaning elements of the first toothbrush and the cleaning elements of the second toothbrush contact the test surface simultaneously and under approximately equal pressures.

### BRIEF DESCRIPTION OF THE DRAWINGS

FIG. 1 is a schematic plan view of the toothbrush-demonstration device of the disclosure.

FIG. 2 is a schematic perspective view of a toothbrush-demonstration system comprising the toothbrush-demonstration device, two toothbrushes securely fixed therein, and a test surface comprising a tooth-surface-simulating substrate.

FIG. 3 is a schematic plan view of the device similar to that shown in FIG. 1, and including an electro-mechanical drive.

FIG. 4 is a schematic cross-sectional view of the embodiment of FIG. 3, taken along the lines 4-4 (but not showing the electro-mechanical drive).

FIG. 5 is a schematic front view of the embodiment of the device shown in FIG. 1, having a pair of screws for moving a lower plate and an upper plate relative to one another.

FIG. 6 is a schematic front view of an embodiment of the device having a single screw for moving a lower plate and an upper plate relative to one another.

### DETAILED DESCRIPTION OF THE INVENTION

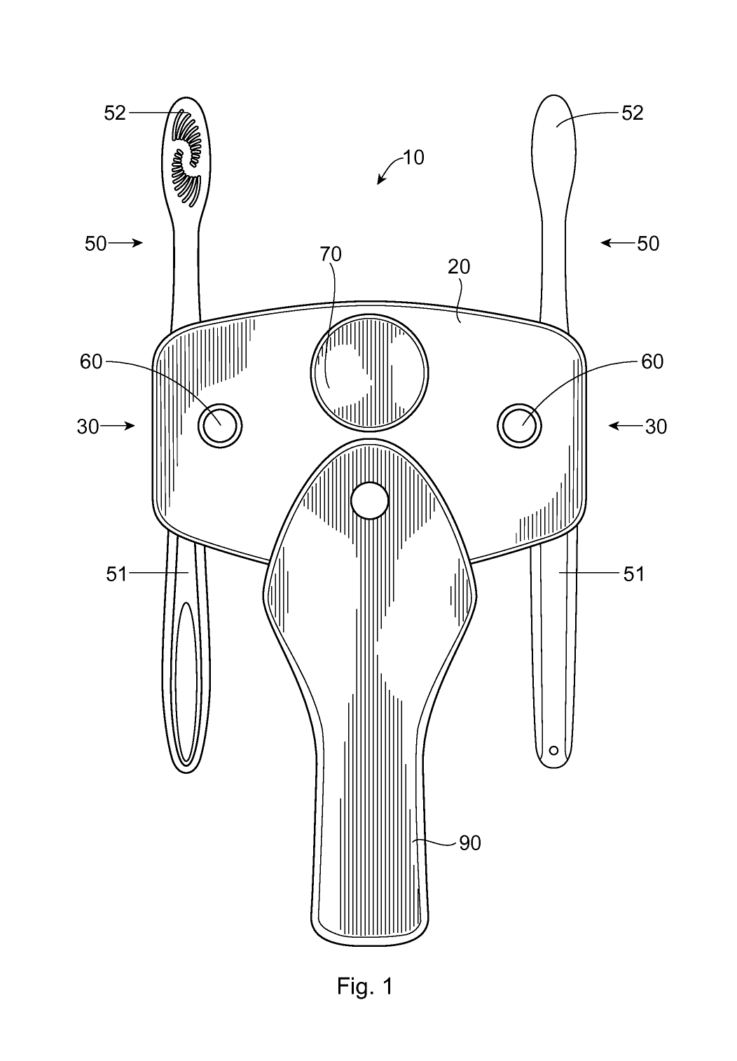

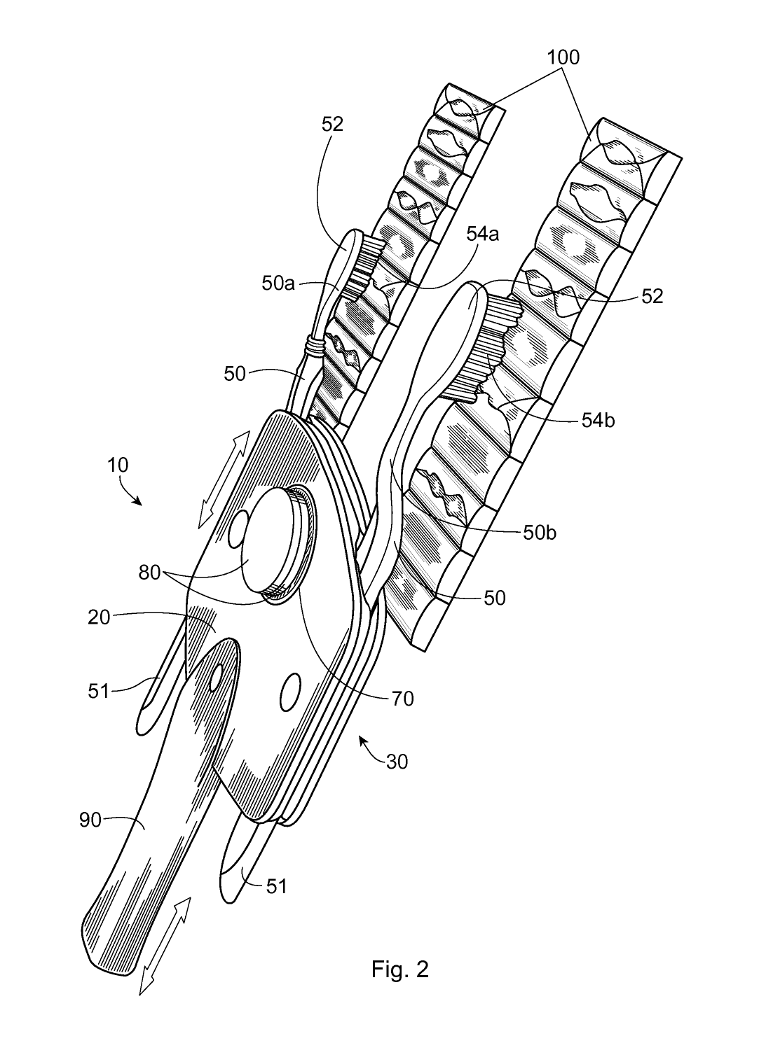

A toothbrush-demonstration device 10 has a main body 20 comprising a plurality of toothbrush holders 30, FIG. 4. Each of the toothbrush holders 30 is structured and configured to accept and removably secure therein a single toothbrush 50 in a fixed position, FIGS. 1 and 2. Virtually any toothbrush type, including manual and electrical toothbrushes, can be mounted and securely fixed in the device's holder 30. As one skilled in the art would appreciate, a typical toothbrush comprises a handle 51 and a head 52 having a support element 53 and a plurality of cleaning elements 54 outwardly extending from the support element 53, FIGS. 1 and 2. The holders 30 are structured and configured to provide for parallel mount of the plurality of toothbrushes 50 therein, as shown in FIGS. 1 and 2. While the embodiment shown in several figures herein illustrate a configuration of the device 10 comprising two toothbrush holders 30, embodiments are contemplated that can have more than two toothbrush holders 30 (not shown).

The device 10 can include a mechanical clamping mechanism. In the embodiment of the device 10 shown in FIGS. 1 and 2, the clamping mechanism includes an upper plate 21 having a first inner surface 21a, a lower plate 22 having a second inner surface 22a, and a pair of screws 60 disposed at opposite sides of the device's main body 20, FIG. 4. An embodiment of the device 10 shown in FIG. 6 includes a single screw 60, positioned approximately equidistantly intermediate the toothbrush holders 30. The first inner surface 21a is facing, substantially parallel to, and is spaced from, the second inner surface 22a. The first and second inner surfaces 21a, 22a can beneficially comprise, or be lined up with, a resilient element 25, such as, e.g., elastomer, that can resiliently yield under pressure to tightly embrace surfaces of the toothbrushes 30 being clamped between the first and second inner surfaces 21a, 22a, in order to securely mount the toothbrushes therebetween.

The upper and lower plates 21, 22 can be coupled to one another for a movement relative to one another such that a distance between the first inner surface 21a and the second inner surface 22a can be varied. Two or more couples of mutually opposite clamping surfaces 21b, 22b can be formed in the first and second inner surfaces 21a, 22a, respectively, FIG. 4. These clamping surfaces 21b, 22b can be structured and configured to apply a clamping force to a portion of a body of the toothbrush 50 being fastened therein, thereby “sandwiching” the toothbrushes between the two clamping plates 21, 22.

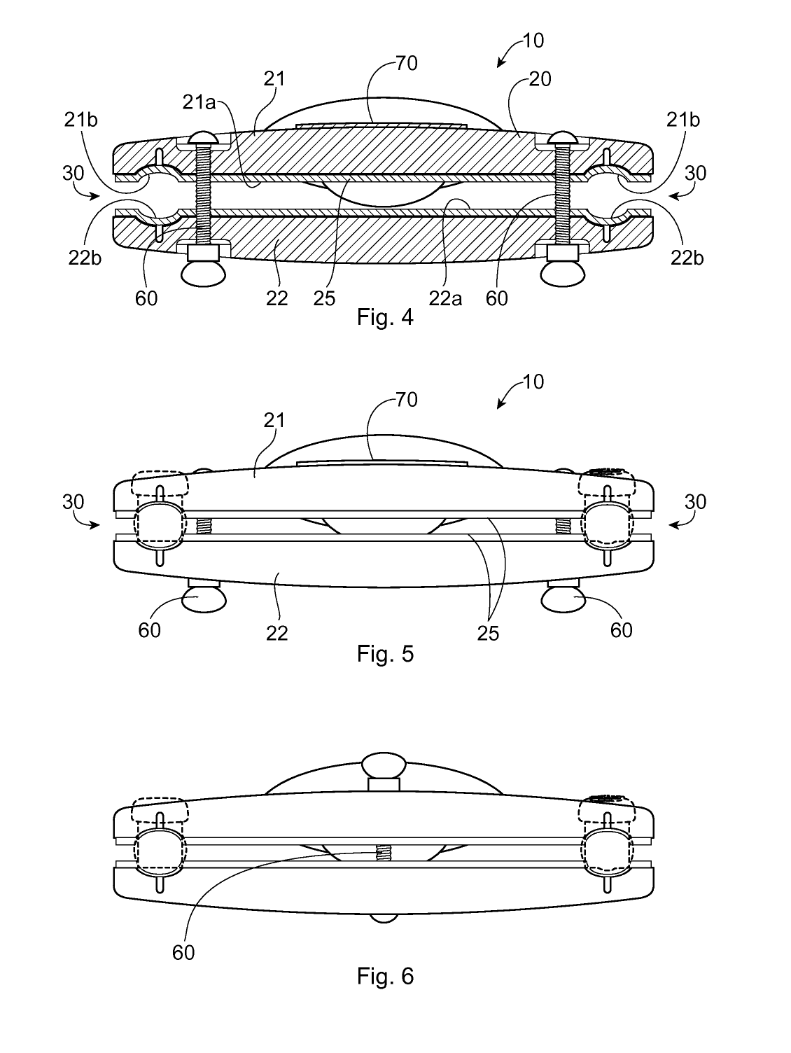

While FIGS. 4 and 5 show an embodiment in which a structure of the clamping surfaces 21b, 22b comprises concave portions, one skilled in the art would readily recognize that other embodiments of the clamping surfaces 21b, 22b can also be had. For example, the clamping surfaces 21b, 22b having a substantially flat, i.e., non-concave, shape are also contemplated by the invention. In such an embodiment, a relatively thick layer of the resilient element 25 can be provided to accommodate the shape of the toothbrushes' portions being clamped between the clamping surfaces 21b, 22b. The resilient element 25 and/or the configuration of the clamping surfaces 21b, 22b can be beneficially selected to allow the toothbrush holders 30 of the device 10 to accept toothbrushes 50 having differential shapes and sizes, without replacing the plates 21, 22 and without providing additional adjustments to the toothbrush holders 30.

The device 10 may optionally comprise a weight-adjusting means for adjusting an overall weight of the device 10. This can be beneficial for simulating a desirable pressure of the toothbrush against the teeth recommended for tooth brushing. The weight-adjusting means may comprise a weight receptacle 70, located, e.g., on the upper plate 21 of the device's body 20, for receiving at least one additional-weight element 80, FIG. 2.

The device 10 may conveniently include a handle 90 for manual movement of the device 10, including movement of the device relative to a test surface 100 simulating a surface of a tooth. The test surface 100 may comprises any suitable surface, e.g., that of teeth-shaped acrylic molds, capable of retaining a stain-imitating or plaque-imitating materials and interacting with the cleaning elements 54. Non-limiting examples of the test surface's shapes include surfaces imitating occlusal, buccal, and lingual surfaces of the teeth. Non-limiting examples of plaque/stain-imitating materials include acrylic paint and black-tea or coffee solutions. Particulate materials, such as, e.g., ground coffee, with or without adhesive material, can also be applied to the surface for demonstration purposes.

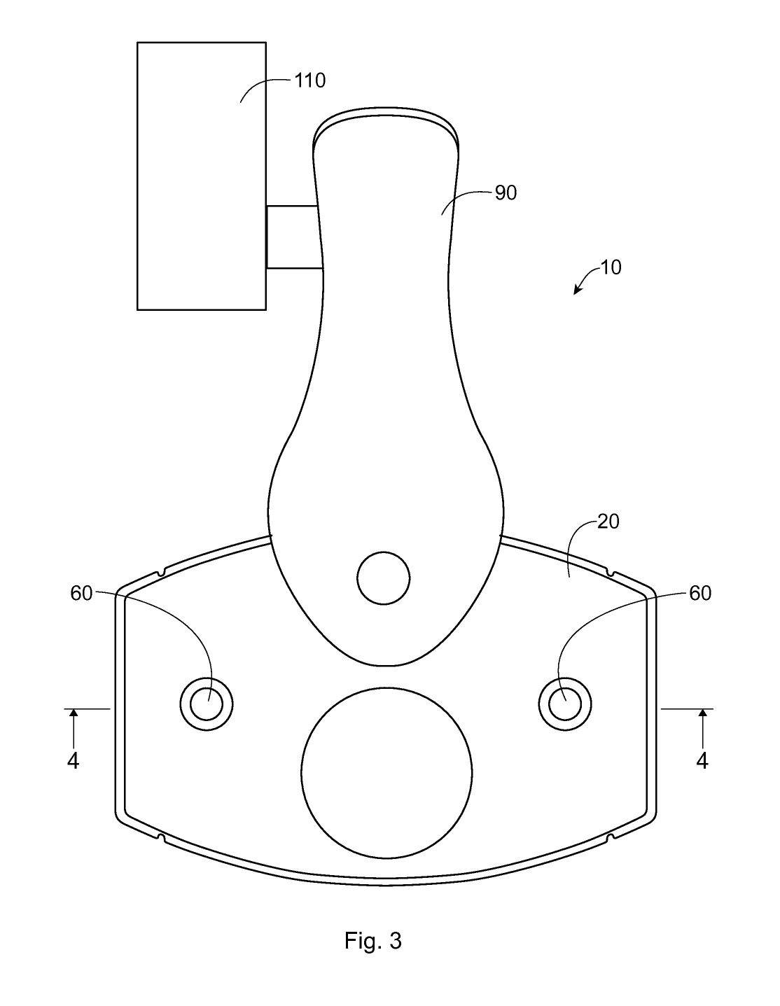

In another embodiment, the device 10 may include an electro-mechanical drive 110 for mechanical movement of the device 10 relative to the test surface 100, FIG. 3. One skilled in the art would recognize that in such an embodiment of the device 10, the handle 90, intended for a manual movement of the device 10, may not be needed. Any suitable electro-mechanical drive 110 can be utilized, such as, e.g., an alternating-current or a battery-powered slider-crank mechanism or any other mechanism intended to convert rotational mechanical power from an electric motor into linear reciprocating motion at a substantially-constant frequency, as one skilled in the art would readily recognize. While linear reciprocating motion at a constant frequency may not precisely correspond to consumers' habits in using a toothbrush, such motion may provide for an improved demonstration or comparison of two different brushes, free from variation or bias, which may be introduced or have the appearance of being introduced when brushes are operated directly by hand. Frequencies of approximately thirty strokes per minute to approximately ninety strokes per minute and peak-to-peak stroke amplitudes of approximately one centimeter to approximately ten centimeters may be used.

As a skilled artisan would realize, the use of a hinge or a rotational bearing are two commonly known methods of preventing the transfer of a bending moment through otherwise-rigid elements in a kinetic linkage. The mechanically driven device 10 can be beneficially provided with a hinge (not shown) separating the drive 110 from the device 10, to assure that the weight of the device 10 does not interfere with the operation of the drive 110. This would prevent transfer of bending moment from the weight of the device 10, including the weight of the additional-weight elements 80, through the device's body 20, toothbrush holders 30, and other elements of the linkage to any vertical-load-bearing element in the handle 90 or the electro-mechanical drive 110—and would allow one to assure the transfer of a prescribed force.

FIG. 2 shows an embodiment of the toothbrush-demonstration device 10, in combination with at least two different toothbrushes 50 secured therein for simultaneous movement relative to the test surface 100, as described herein. The toothbrushes 50 are securely mounted in the toothbrush holders 30 in a substantially parallel relationship to one another so that the cleaning elements 54 of each of the two toothbrushes 50 extend in a direction away from the main body 20 of the device 10. The toothbrushes 50 are disposed in the holders 30 so that the cleaning elements 54 of the toothbrushes 50 touch the test surface 100 simultaneously and under approximately equal pressure against the test surface 100.

Several figures herein schematically show “generic” toothbrushes 50. One skilled in the art would readily appreciate that the toothbrushes 50 can comprise manual toothbrushes and electrical toothbrushes. The device 10 of the disclosure is capable of accepting virtually any toothbrush type. The toothbrushes 50 tested in the device 10 can be selected to differ from one another based on the source of the product. In addition, the toothbrushes 50 can differ from one another based on shape, size, and similar physical characteristic(s) of the toothbrush body. Also, the toothbrushes 50 can differ with respect to material, size, shape, pattern of the cleaning elements, and other characteristics affecting the plague-removal efficacy of the toothbrushes 50. When the device 10 is used to test electrical toothbrushes, the brushes 50 can differ from one another in pattern and frequency of a mechanical movement of the cleaning elements. If the device is used in combination with manual toothbrushes, the toothbrushes 50 can be selected to differ from one another in at least one characteristic selected from the group consisting of material, size, shape, and pattern of the cleaning elements, as well as other relevant characteristics believed to have an effect on the plague-removal efficacy of the toothbrushes 50.

A toothbrush-demonstration system, shown in FIG. 2, comprises at least a first toothbrush 50a and a second toothbrush 50b, each of the toothbrushes 50a, 50b comprising a handle 51 and a head 52 including a plurality of cleaning elements 54; the toothbrush-demonstration device 10, as described herein; and the test surface 100 comprising a tooth-surface-simulating substrate, as described herein. In the embodiment shown, the cleaning elements 54a of the first toothbrush 50a and the cleaning elements 54b of the second toothbrush 50b extend in a direction substantially perpendicular to the test surface 100, and tips of the cleaning elements 54a, 54b are substantially aligned with respect to the test surface 100. This allows one to cause the tips of the bristles 54a, 54b to touch the test surface simultaneously and under approximately equal pressure.

A process for demonstrating efficacy of one toothbrush relative to another toothbrush, which can be performed using the described device 10, comprises fastening first and second toothbrushes 50a, 50b to the toothbrush-demonstration device 10 and moving the device 10 with the toothbrushes 50 secured therein relative to a test surface 100 and in a direction substantially parallel to the first and second toothbrushes' longitudinal axes so that the cleaning elements 54a of the first toothbrush 50a and the cleaning elements 54b of the second toothbrush 50b contact the test surface 100 simultaneously and under approximately equal pressures. As one skilled in the art would readily recognize, a dentifrice can optionally be applied, if it is desired to demonstrate a combined effect of the brush or brushes and the dentifrice. The test surface 100 can include plaque-imitating, stain-imitating, and food-debris-imitating substances, such as, e.g., ground coffee and similar particulate material.

While particular embodiments have been illustrated and described herein, various other changes and modifications may be made without departing from the spirit and scope of the invention. Moreover, although various aspects of the invention have been described herein, such aspects need not be utilized in combination. It is therefore intended to cover in the appended claims all such changes and modifications that are within the scope of the invention.

The terms “substantially,” “essentially,” “about,” “approximately,” and the like, as may be used herein, represent the inherent degree of uncertainty that may be attributed to any quantitative comparison, value, measurement, or other representation. These terms also represent the degree by which a quantitative representation may vary from a stated reference without resulting in a change in the basic function of the subject matter at issue. Further, the dimensions and values disclosed herein are not to be understood as being strictly limited to the exact numerical values recited. Instead, unless otherwise specified, each such dimension is intended to mean both the recited value and a functionally equivalent range surrounding that value. For example, values disclosed as “80%” or “2 mm” are intended to mean “about 80%” or “about 2 mm,” respectively.

The disclosure of every document cited herein, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein—or that it alone, or in any combination with any other reference or references, teaches, suggests, or discloses any such invention. Further, to the extent that any meaning or definition of a term in this document conflicts with any meaning or definition of the same or similar term in a document incorporated by reference, the meaning or definition assigned to that term in this document shall govern.

What is claimed is:

1. A toothbrush-demonstration device having a main body and comprising a plurality of toothbrush holders, each of the toothbrush holders being structured and configured to accept and removably secure therein a single toothbrush in a fixed position, the toothbrush comprising a handle and a head including a plurality of cleaning elements, wherein a plurality of toothbrushes can be securely mounted substantially parallel to one another in the plurality of toothbrush holders for a simultaneous movement with the device relative to a test surface simulating teeth surfaces.

2. The device of claim 1, wherein the device comprises at least one mechanical clamping mechanism for securing the toothbrushes in the toothbrush holders.

3. The device of claim 2, wherein the at least one mechanical clamping mechanism includes at least one screw.

4. The device of claim 2, wherein the mechanical clamping mechanism comprises at least a first clamping surface and a second clamping surface opposite to the first clamping surface, the first and second clamping surfaces being structured and configured to apply a clamping force to a portion of a body of the toothbrush being secured therein.

5. The device of claim 1, wherein the device comprises an upper plate having a first inner surface and a lower plate having a second inner surface, wherein the first inner surface is facing, substantially parallel to, and spaced from, the second inner surface, the upper and lower plates being coupled to one another for a movement relative to one another such that a distance between the first inner surface and the second inner surface can be varied.

6. The device of claim 5, wherein the first inner surface includes a plurality of first clamping surfaces and the second inner surface includes a plurality of second clamping surfaces, the first and second clamping surfaces being structured and configured to form a plurality of clamping couples for accepting and securing the plurality of toothbrushes therein.

7. The device of claim 6, wherein the plurality of clamping couples is structured and configured to accept and secure therein toothbrushes having differential shapes.

8. The device of claim 1, wherein the device includes a weight receptacle for receiving at least one additional-weight element.

9. The device of claim 5, wherein the upper plate and the lower plate are coupled to one another by at least one coupling element for a relative movement.

10. The device of claim 9, wherein the at least one coupling element comprises at least one screw.

11. The device of claim 9, wherein the at least one coupling element comprises at least a first screw and a second screw, the first and second screws being disposed at opposite sides of the device.

12. The device of claim 1, wherein the device includes a handle for manual movement of the device relative to the test surface.

13. The device of claim 1, wherein the device includes an electrical drive for mechanical movement of the device relative to the test surface.

14. A toothbrush-demonstration device, in combination with at least two different toothbrushes secured therein for simultaneous movement relative to a test surface, the device having a main body and comprising at least two toothbrush holders for accepting and securely mounting the toothbrushes therein, each of the toothbrushes comprising a handle and a head including a plurality of cleaning elements, wherein the toothbrushes are securely mounted in the toothbrush holders in a substantially parallel relationship to one another and wherein the cleaning elements of the toothbrushes extend in a direction away from the main body of the device so that the cleaning elements of the toothbrushes touch the test surface simultaneously and under approximately equal pressure against the test surface.

15. The device of claim 14, wherein the at least two different toothbrushes comprise a first electrical toothbrush and a second electrical toothbrush, and wherein the first electrical toothbrush differs from the second electrical toothbrush in at least one characteristic selected from the group consisting of: shape and size of the handle; material, size, shape, and pattern of the cleaning elements; pattern of a mechanical movement of the cleaning elements, and frequency of the mechanical movement of the cleaning elements.

16. The device of claim 14, wherein the at least two different toothbrushes comprise a first manual toothbrush and a second manual toothbrush, and wherein the first manual toothbrush differs from the second manual toothbrush in at least one characteristic selected from the group consisting of: shape and size of the handle; and material, size, shape, and pattern of the cleaning elements.

17. A toothbrush-demonstration system comprising:
at least a first toothbrush and a second toothbrush, each of the toothbrushes comprising a handle and a head having a support element and a plurality of cleaning elements outwardly extending from the support element;
a toothbrush-demonstration device having a main body and comprising at least a first toothbrush holder and a second toothbrush holder, the toothbrush holders being structured and configured to accept and removably secure therein the first and second toothbrush, respectively, so that the toothbrushes are substantially parallel to one another; and
a test surface comprising a tooth-surface-simulating substrate.

18. The system of claim 17, wherein the cleaning elements of the first toothbrush and the cleaning elements of the second toothbrush extend in a direction substantially perpendicular to the test surface, and wherein tips of the cleaning elements of the first toothbrush and tips of the cleaning elements of the second toothbrush are substantially aligned with respect to the test surface.

19. The system of claim 17, wherein the tooth-surface-simulating substrate is stained with a plague-simulating substance.

20. A process for demonstrating efficacy of one toothbrush relative to another toothbrush, the process comprising:
fastening a first toothbrush and a second toothbrush to a toothbrush-demonstration device for simultaneous movement therewith relative to a test surface comprising a tooth-surface-simulating substrate, wherein the first toothbrush has a first longitudinal axis and the second toothbrush has a second longitudinal axis, wherein the first toothbrush and the second toothbrush are oriented to have their respective first and second longitudinal axes substantially parallel to each other;
moving the toothbrush demonstration device with the first and second toothbrushes fastened thereto in a direction substantially parallel to the first and second longitudinal axes and relative to a test surface so that the cleaning elements of the first toothbrush and the cleaning elements of the second toothbrush contact the test surface simultaneously and under approximately equal pressures.
